(19) United States
(12) Patent Application Publication
(10) Pub. No.: US 2009/0017950 A1
(43) Pub. Date: Jan. 15, 2009

(54) FLEXIBILE BICYCLE CHAIN

(76) Inventors: MONTANARI SANDRO, Taichung City (TW); Righi Ermanno, Taichung City (TW)

Correspondence Address: MONTANARI SANDRO, 235 Chung - Ho Box 8-24, Taipei, 235, TW

(21) Appl. No.: 11/776,552

(22) Filed: Jul. 12, 2007

(51) Int. Cl. F16G 13/06

(52) U.S. Cl. 474/231

(57) ABSTRACT

A flexible bicycle chain comprises a plurality of chain unit, each chain unit including: two inner chain plates; each inner chain plate having a shape like an “8”, two outer chain plates; each outer chain plate having a shape like an “8”, a size of each outer hole of the outer chain plate being smaller than that of each inner hole of each outer chain plate; a roller unit having a receiving space; a connecting pin received in the receiving space of the roller unit; the connecting pin being longer that the roller unit. Each roller unit includes a middle annular groove, two inclined annular surfaces; the middle annular groove is at a middle section of the roller unit and has a concave cambered shape; and the two inclined annular surfaces are at two ends of the middle annular groove.

### FIELD OF THE INVENTION

The present invention relates to bicycles, and particularly to a flexible bicycle chain, wherein the chain provides a greater flexibility to the bicycle so that in normal driving or in speed change, the bicycle can be operated smoothly.

### BACKGROUND OF THE INVENTION

In basic bicycle structure, a chain of a bicycle is engaged with gears for transferring driving power to the wheel so as to drive the bicycle to move. Furthermore, currently, most bicycles have speed change devices which have a plurality of gears so as to provide different speed levels to the bicycles. However in driving, even in the period of speed change, the chain will bend. If the flexibility of the chain of the bicycle is too low, the movement of the bicycle will not smooth.

In one improvement structure, the chain of the bicycle has roller units and connecting pins. The connecting pin is received in a receiving space of the roller unit. The roller unit is connected to the outer chain plate and inner chain plate. The structures are repeated and are connected one by one so as to form as a chain of a bicycle. In the improved structure, the pin is formed with a nose portion or a flange so that the pin is not completely adhered to an inner surface of the roller unit. As a result, the chain is a great margin as the chain is bent.

However the structure provides a greater flexibility than the prior art structure, but it still has some defects. In change speed, the roller unit will shift so that gaps are formed between the connecting pin and the roller unit. The gaps will make the roller unit is not effectively engaged to the connecting pin. Thus the action of the chain is not some efficient as desired. Furthermore, the contact areas of the connecting pin and roller unit suffer from greater stresses so as to have greater friction forces. Thus, for a long time, the roller unit and connecting pin are worn and can not work normally.

### SUMMARY OF THE INVENTION

Accordingly, the primary object of the present invention is to provide a flexible bicycle chain, wherein the chain provides a greater flexibility to the bicycle so that in normal driving or in speed change, the bicycle can be operated smoothly.

To achieve above objects, the present invention provides a flexible bicycle chain comprising a plurality of chain unit, each chain unit including: two inner chain plates; each inner chain plate having a shape like an “8”, thus each inner chain plate having two inner holes; two outer chain plates; each outer chain plate having a shape like an “8”, each outer chain plate having two outer holes; a size of each outer hole of the outer chain plate being smaller than that of each inner hole of each outer chain plate; a roller unit having a receiving space; a connecting pin received in the receiving space of the roller unit; the connecting pin being longer that the roller unit; and wherein each roller unit includes a middle annular groove, two inclined annular surfaces; the middle annular groove is at a middle section of the roller unit and has a concave cambered shape; the two inclined annular surfaces are at two ends of the middle annular groove; each inclined annular surface is inclined with a small opening at an end near the middle annular groove and a large opening at an end far away from the middle annular groove.

The various objects and advantages of the present invention will be more readily understood from the following detailed description when read in conjunction with the appended drawing.

### BRIEF DESCRIPTION OF THE DRAWINGS

FIG. 1 is an exploded view of each chain unit of the present invention.

FIG. 2A is a schematic cutting view includes the roller unit of the present invention.

FIG. 2B is a cross sectional view about the roller unit of the present invention.

FIG. 3 is an assembly view of the chain unit of the present invention.

FIG. 4 is a schematic cross sectional view along line 3AB of the present invention.

FIG. 5A is a schematic view showing a non-curved chain according to the present invention.

FIG. 5B is a schematic view showing a curved chain according to the present invention.

FIG. 6 is a perspective view of the second embodiment of the present invention.

FIG. 7A is a schematic cross sectional view about the second embodiment of the present invention.

FIG. 7B is a partial enlarged view of the FIG. 7A.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

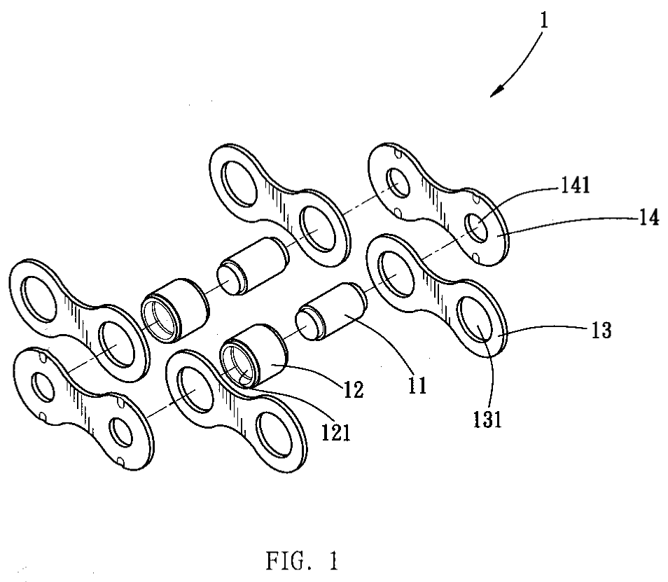

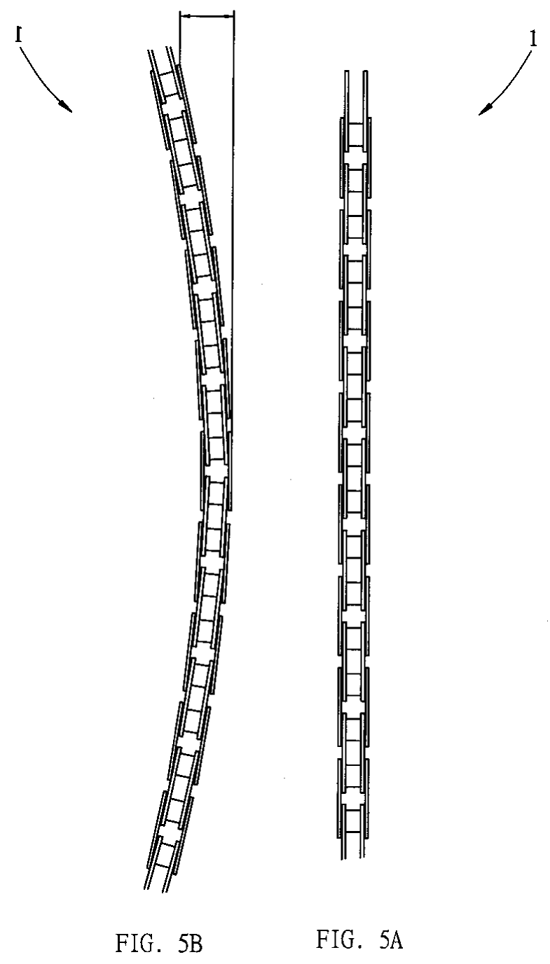

Referring to FIG. 1 the bicycle chain assembly of the present invention is illustrated. The chain 1 according to the present invention is formed by a plurality of chain unit, as illustrated in FIGS. 5A and 5B. Each chain unit has the following elements.

Two inner chain plates 13 are included. Each inner chain plate 13 has a shape like an “8”. Thus, each inner chain plate 13 has two inner holes 131.

Two outer chain plates 14 are included. Each outer chain plate 14 has a shape like an “8”. Thus, each outer chain plate 14 has two outer holes 141. A size of each outer hole 141 of the outer chain plate 14 is smaller than that of each inner hole 131 of each outer chain plate 14.

A roller unit 12 has a receiving space 121. Two ends of the roller unit 12 are reduced to have a diameter smaller than other portion of the roller unit 12. The diameter of the reduced portions of the roller unit 12 is approximately equal to the size of the inner hole 131 of the inner chain plate 13.

A connecting pin 11 is received in the receiving space 121 of the roller unit 12. The connecting pin 11 is longer than the roller unit 12. Two ends of the connecting pin 11 are reduced to have a small diameter than other portion of the connecting pin 11. The diameter of the reduced portions of the roller unit 12 is approximately equal to that of the outer hole 141 of the outer chain plate 14.

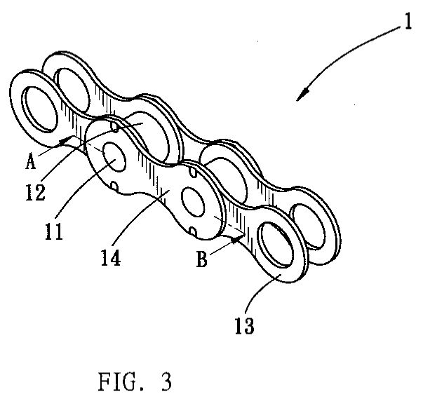

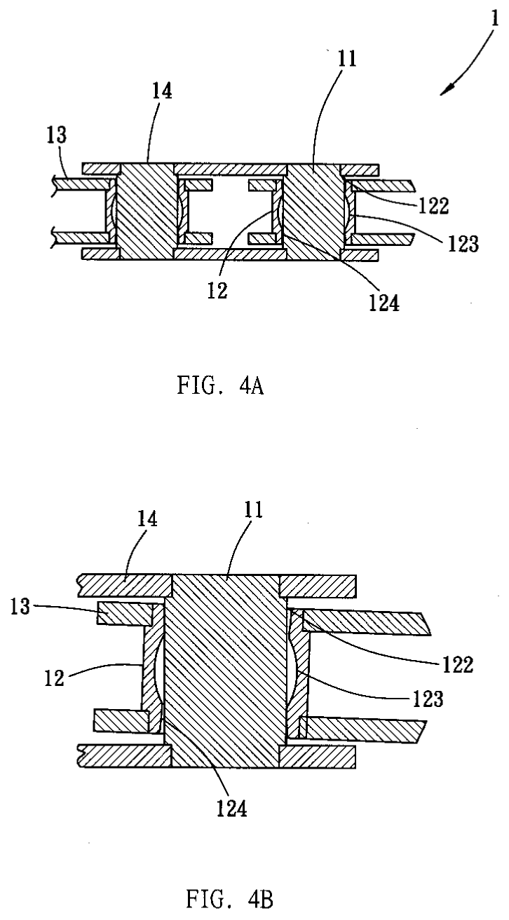

Referring to FIGS. 3 and 4A, it is illustrated that in assembly, the connecting pin 11 is installed in the receiving space 121 of the roller unit 12. The two ends of the roller unit 12 are received into the inner holes 131 of two inner chain plates 13 at two ends. Other portion of the roller unit 12 resists against the two inner chain plates 13. The two ends of the connecting pin 11 are received into the outer holes 141 of the two outer chain plates 14. Other portion of the connecting pin 11 resists against the two outer chain plates 14.

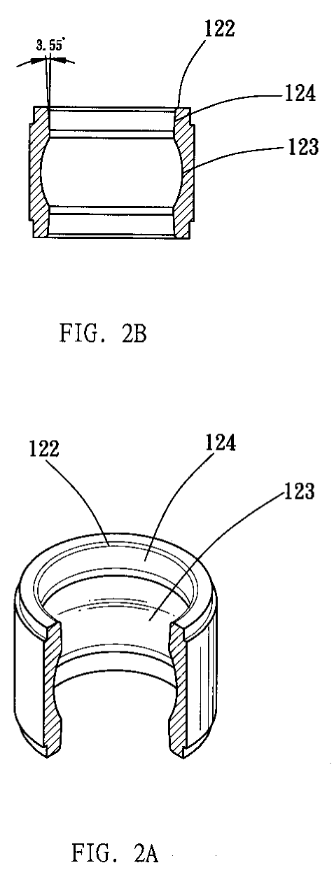

Referring to FIGS. 2A and 2B, it is illustrated that each roller unit 12 includes a middle annular groove 123, two inclined annular surfaces 124 and two outer inclined annular surfaces 122. The middle annular groove 123 is at a middle section of the roller unit 12 and has a concave cambered shape. The two inclined annular surfaces 124 are at two ends of the middle annular groove 123. Each inclined annular surface 124 is inclined with a small opening at an end near the middle annular groove 123 and a large opening at an end far away from the middle annular groove 123. A slope of each inclined annular surface 124 with respect to an axis is about 3.55 degrees. The two outer inclined annular surfaces 122 are at two outer ends of the two inclined annular surfaces 124. The two outer inclined annular surfaces 122 are at two openings of the receiving space 121. The slope of each outer inclined annular surface 122 with respect to the axis of the receiving space 121 is great to the slope of each inclined annular surface 124.

Referring to FIGS. 4A, 4B, 5A and 5B, the effect of the present invention will be described herein. In FIG. 4A, it is illustrated that in normal state (see FIG. 5A), the inner chain plates 13 and outer chain plates 14 are all in parallel. The roller unit 12 are only point-contacted with the outer chain plates 14 and inner chain plates 13. Referring to FIG. 4B, in moving, when the chain is bent (see FIG. 5B), the inner chain plates 13 are inclined to the outer chain plates 14, the roller unit 12 is shifted in the receiving space 121, while the design of the present invention provides a larger shift margin for the shift of the roller unit 12 so that when the chain 1 is bent, the roller unit 12 moves smoothly. Especially in change speed, the present invention has better effects that the prior art structure.

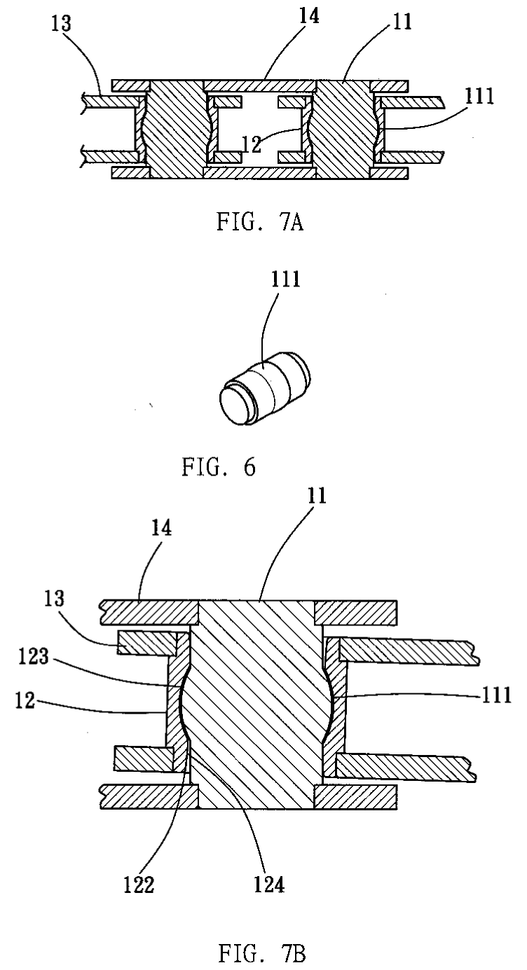

Referring to FIGS. 6, 7A and 7B, the second embodiment of the present invention is illustrated. In this embodiment, those identical to the above embodiment will not be further described herein. Only those different from above embodiment are described. In this embodiment, a middle section of the connecting pin 11 has a convex cambered surface 111 which has a size approximately equal to that of the middle annular groove 123 so that in assembly, the convex cambered surface 111 is received in the middle annular groove 123. This structure makes the connecting pin 11 being tightly adhered to the receiving space 121 of the roller unit 12 so as to provide a preferred flexibility to the chain.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A flexible bicycle chain comprising a plurality of chain unit, each chain unit including:
two inner chain plates; each inner chain plate having a shape like an “8”, thus each inner chain plate having two inner holes;
two outer chain plates; each outer chain plate having a shape like an “3”, each outer chain plate having two outer holes; a size of each outer hole of the outer chain plate being smaller than that of each inner hole of each outer chain plate;
a roller unit having a receiving space;
a connecting pin received in the receiving space of the roller unit; the connecting pin being longer that the roller unit; and
wherein each roller unit includes a middle annular groove, two inclined annular surfaces; the middle annular groove is at a middle section of the roller unit and has a concave cambered shape; the two inclined annular surfaces are at two ends of the middle annular groove; each inclined annular surface is inclined with a small opening at an end near the middle annular groove and a large opening at an end far away from the middle annular groove.

2. The flexible bicycle chain as claimed in claim 1, wherein a slope of each inclined annular surface with respect to an axis of the roller unit is about 3.55 degrees.

3. The flexible bicycle chain as claimed in claim 1, further comprising two outer inclined annular surfaces are at two outer ends of the two inclined annular surfaces; the two outer inclined annular surfaces are at two openings of the receiving space; and the slope of each outer inclined annular surface with respect to the axis of the receiving space is great to the slope of each inclined annular surface.

4. The flexible bicycle chain as claimed in claim 1, wherein two ends of the roller unit are reduced to have a diameter smaller than other portion of the roller unit; the diameter of the reduced portions of the roller unit is approximately equal to the size of the inner hole of the inner chain plate; and two ends of the connecting pin are reduced to have a small diameter than other portion of the connecting pin; and the diameter of the reduced portions of the roller unit is approximately equal to that of the outer hole of the outer chain plate.

5. The flexible bicycle chain as claimed in claim 1, wherein in assembly, the connecting pin is installed in the receiving space of the roller unit; the two ends of the roller unit are received into the inner holes of two inner chain plates at two ends; other portion of the roller unit resists against the two inner chain plates; the two ends of the connecting pin are received into the outer holes of the two outer chain plates; other portion of the connecting pin resists against the two outer chain plates.

6. The flexible bicycle chain as claimed in claim 1, wherein a middle section of the connecting pin has a convex cambered surface which has a size approximately equal to that of the middle annular groove so that in assembly, the convex cambered surface is received in the middle annular groove.
